(19) United States
(12) Patent Application Publication
(10) Pub. No.: US 2007/0160804 A1
(43) Pub. Date: Jul. 12, 2007

(54) End cap for roofing panels

(76) Inventor: Christopher Richardson, Lancashire (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/547,625

(22) PCT Filed: Mar. 1, 2004
(86) PCT No.: PCT/GB04/00830

§ 371 Date: May 9, 2006

(30) Foreign Application Priority Data
Mar. 1, 2003 (GB) 0304752.9

(51) Int. Cl. B32B 3/04; E04C 2/38

(52) U.S. Cl. 428/122; 52/716.8

(57) ABSTRACT

An end cap (10) for use with ducted glazing panels comprises a channel section member having an intended upper side wall (12), a base (14) and an intended lower side wall (16), the upper and lower side walls being angled relative to the base, whereby, when fitted to a glazing panel and the panel is installed in a pitched roof, the base of the end cap is substantially vertical.

This invention concerns installation of roofing panels.

Conservatories and like structures can have a roof structure comprising glazing bars extending from one or both sides of a ridge member with glazing panels supported between the glazing bars. A common glazing material is polycarbonate sheeting, which may have two or three layers joined at their edges and intermediate their edges to form longitudinal ducts through the panels. When such panels are fitted to a conservatory roof, the ends of the panels are sealed with a breather tape to prevent ingress of water and insects into the ducts of the panels. The ends of the panels were then covered with a simple polycarbonate cap.

However, polycarbonate panels are not completely flat, so that some ingress of water was still possible. In GB 2283997, it was proposed that end caps for glazing panels comprise a channel section member having an intended upper side and an intended lower side, the upper side including a co-extruded gasket extending from and beyond its free edge, whereby, when the end cap is pushed onto the glazing panel, the gasket lies on the panel surface to limit passage of water past the gasket.

These end caps had a channel base that, in use, was generally normal to the plane of the panel. A problem with that arrangement is that rain water flowing down a glazed roof tends to drip off the end cap over a wide arc, because some rain water will drip off from the top edge of the end cap, whilst some will flow down the end cap to drip off its bottom edge, which is in board of the top edge. Thus, the gutter for such a roof has to be fairly wide to catch substantially all of the rain flowing down the roof.

An object of this invention is to provide an improved end cap for use with ducted glazing panels.

According to this invention there is provided an end cap for use with ducted glazing panels comprising a channel section member having an intended upper side wall, a base and an intended lower side wall, the upper and lower side walls being angled relative to the base, whereby, when fitted to a glazing panel and the panel is installed in a pitched roof, the base of the end cap is substantially vertical.

The free edge of the upper side wall preferably has gasket material thereon for sealing against a top surface of a glazing panel, in use. The gasket material may be of rubber or other suitable synthetic elastomeric material. The gasket material preferably has its free edge angled towards the lower side wall.

The lower side wall preferably has at least one strip or rib of gasket material on its inner surface for sealing against the underside of a glazing panel, in use. Again the gasket material can be of rubber or of synthetic elastomeric material. Preferably three strips of gasket material are provided on the inner surface of the lower side wall and preferably the or each strip or rib of gasket material is angled towards the base of the end cap.

The lower side wall of the end cap preferably has a first part that is normal to the base of the end cap and a second end part that is angled towards the upper side wall. The free edge of the lower side wall preferably curves away from the upper side wall.

Within the end cap associated with the upper and lower side walls are a pair of longitudinal ribs to act as stops for a glazing panel, onto which the end cap is fitted. The stop of the lower side wall is preferably spaced from the base and is preferably in the region where the first and second parts of the lower side wall meet.

The lower side wall also preferably has a series of drainage holes formed therein at spaced intervals along its length. The drainage holes are preferably in the aforesaid region where the first and second parts of the lower side wall meet.

In use, an end cap of the invention is pushed onto a glazing panel up to the stops. Because of the angles of the side walls relative to the base, it is possible for the base to be substantially vertical when the end cap is on a roofing panel in a pitched roof. Consequently, rainwater from the panel will drip off the end cap in a relatively confined area.

This invention will now be further described, by way of example only, with reference to the accompanying drawings, in which:

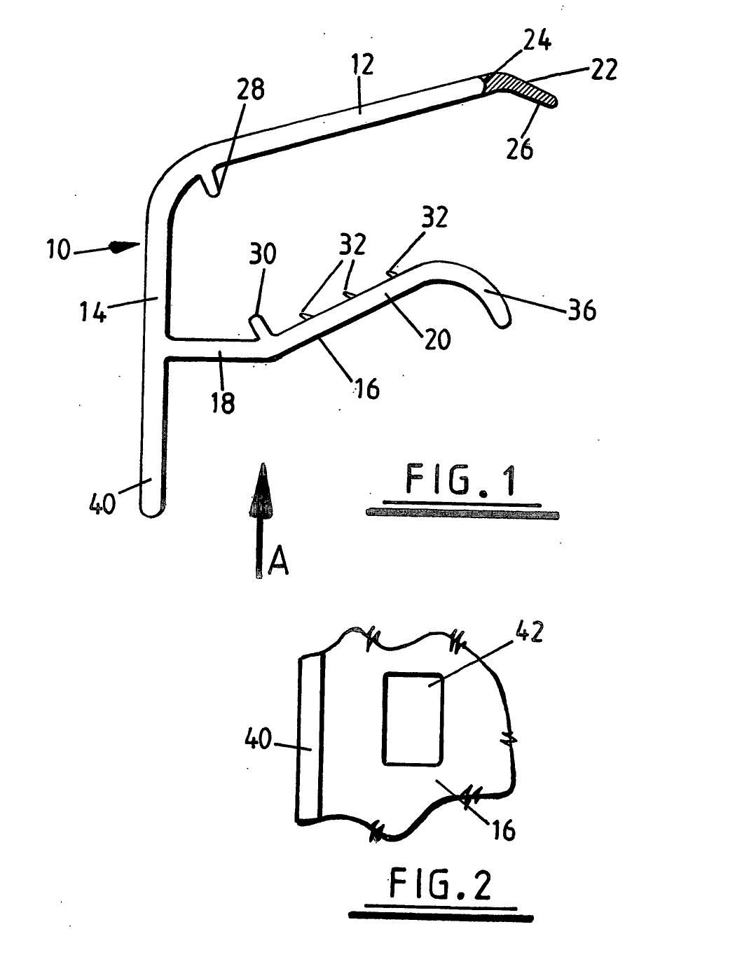

FIG. 1 is an end view of a glazing panel end cap of the invention; and

FIG. 2 is a view on arrow A of FIG. 1.

Referring to the accompanying drawings, an end cap 10 for use on ends of plastics glazing panels, especially ducted polycarbonate glazing panels, comprises a channel section member having an upper side wall 12, a base 14 and a lower side wall 16. The end cap 10 is made by extruding PVC. The upper side wall 12 extends from the base including an obtuse angle. The lower side wall has a first part 18 extending normally to the base and a second part 20 converging towards the upper side wall.

The upper side wall 12 has along its free edge a co-extruded gasket of rubber or synthetic elastomeric material 22. The. gasket material may, of course, be applied to the free edge of the upper side wall in any other suitable way, such as by bonding. The gasket has a first part 24 of similar thickness to the upper side wall and extending collinearly with the side wall and a second end part 26 angled downwards towards the lower side wall and narrowing in thickness towards its free edge. The shaping of the gasket material is to ensure that, when the end cap is on a glazing panel, the gasket maintains sealing contact with the top surface of the glazing panel. Running along the inside of the end cap where the base and upper wall meet is a rib 28 that acts as a stop for a glazing panel, onto which the end cap has been pushed.

The lower side wall 16 of the end cap has on its inner face, where its first and second parts meet a second rib 30 that also acts as a stop for a glazing panel. The inside surface of the second part of the lower side wall of the end cap has a series of gasket strips 32 co-extruded or otherwise bonded thereon. The gasket strips 32 are angled towards the base of the end cap and provide grip between the lower side wall and a glazing panel.

The lower side wall 16 has its free edge 36 curving away from the upper side wall. That shaping of the lower side wall facilitates pushing of the end cap onto a glazing panel. Also, the end cap side walls being of plastics material will have some inherent resilience that will allow them to diverge as a glazing panel is pushed into the end cap but will then exert clamping pressure on the glazing panel to hold the end cap in place and to improve the seals created by the gasket material on the upper and the lower side walls.

The base of the end cap continues below the lower side wall to provide a foot 40.

As can be seen in FIG. 2 of the drawings, the lower side wall 16 of the end cap has a series of drainage holes 42 punched therein along its length. The holes 42 are mainly intended to allow any collected condensation to be drained away.

In use, the end cap 10 is pushed onto the end of a polycarbonate glazing panel. The curving of the lower side wall facilitates the insertion of the glazing panel past the gasket. The end cap is pushed on to the glazing panel until the panel contacts the ribs 28 and 30. In the fitted position, the gasket 22 lies on the top surface of the panel to prevent passage of water into the end cap.

In forming a roof with glazing panels having end caps 10 fitted, the end caps will be at the lower ends of the panels. Because of the angle of the upper and lower side walls and the positions of the stops 28 and 30, the base of the end cap will be substantially vertical. Any rainwater flowing down the roof will drip off the end cap over a relatively narrow arc compared to a prior art end cap. Thus, gutters for such a roof can be made narrower and can be fitted further under the roof edge, so becoming less obtrusive than hitherto.

As well as being usable for plastics glazing panels, the end caps of the invention may also be used on roof panels of glass.

1. An end cap for use with ducted glazing panels comprising a channel section member having an intended upper side wall, a base and an intended lower side wall, the upper and lower side walls being angled relative to the base, whereby, when fitted to a glazing panel and the panel is installed in a pitched roof, the base of the end cap is substantially vertical.

2. An end cap as claimed in claim 1, wherein the free edge of the upper side wall has gasket material thereon for sealing against a top surface of a glazing panel, in use.

3. An end cap as claimed in claim 2, wherein the gasket material is of rubber or other suitable synthetic elastomeric material.

4. An end cap as claimed in claim 2, wherein the gasket material has its free edge angled toward the lower side wall.

5. An end cap as claimed in claim 1, wherein the lower side wall has at least one strip or rib of gasket material on its inner surface for sealing against the underside of a glazing panel, in use.

6. An end cap as claimed in claim 5, wherein the gasket material is of rubber or other suitable synthetic elastomeric material.

7. An end cap as claimed in claim 5, wherein three strips of gasket material are provided on the inner surface of the lower side wall.

8. An end cap as claimed in claim 5, wherein the or each strip or rib of gasket material is angled toward the base of the end cap.

9. An end cap as claimed in claim 1, wherein the lower side wall of the end cap has a first part that is normal to the base of the end cap and a second part that is normal to the base of he end cap and a second aprt that is angled towards the upper side wall.

10. An end cap as claimed in claim 1, wherein the free edge of the lower side wall curves away from the upper side wall.

11. An end cap as claimed in claim 1, wherein within the end cap associated with the upper and lower side walls are a pair of longitudinal ribs to act as stops for a glazing panel, onto which the end cap is fitted.

12. An end cap as claimed in claim 1 1, wherein the stop of the lower side wall is spaced from the base.

13. An end cap as claimed in claim 11, wherein the stop of the lower side wall is in the region where the first and second part of the lower side wall meet.

14. (canceled)

15. (canceled)

16. (canceled)

17. An end cap as claimed in claim 12, wherein the stop of the lower side wall is in the region where the first and second part of the lower side wall meet.

18. An end cap as claimed in claim 1, wherein the lower side wall has a series of drainage holes formed therein at spaced intervals along its length.

19. An end cap as claimed in claim 18, wherein the drainage holes are in the aforesaid region where the first and second part of the lower side wall meet.
